(19) United States
(12) Patent Application Publication
(10) Pub. No.: US 2026/0233583 A1
(43) Pub. Date: Aug. 13, 2026

(54) VEHICLE VENTS WITH OSCILLATING LOUVERS

(71) Applicant: NUSSIE GOTTESMAN, BROOKLYN, NY (US)

(72) Inventor: NUSSIE GOTTESMAN, BROOKLYN, NY (US)

(21) Appl. No.: 19/050,300

(22) Filed: Feb. 11, 2025

(51) Int. Cl. B60H 1/34

(52) U.S. Cl. CPC B60H 1/3421; B60H 2001/3478

(57) ABSTRACT

The vehicle vents with oscillating louvers may include one or more vent units, a controller, and an application program. The one or more vent units may disperse air within a cab of a vehicle. The one or more vent units may vary the orientation of a plurality of louvers such that the air may be redirected to multiple locations within the cab. The orientation of the plurality of louvers may be determined by the controller. The application program executing on a smart device may provide a user interface for the controller.

### CROSS REFERENCES TO RELATED APPLICATIONS

Not Applicable

### STATEMENT REGARDING FEDERALLY SPONSORED RESEARCH

Not Applicable

### REFERENCE TO APPENDIX

Not Applicable

### BACKGROUND OF THE INVENTION

### Field of the Invention

The present invention relates to the field of vehicular ventilation systems, more specifically, vehicle vents with oscillating louvers.

### SUMMARY OF INVENTION

The vehicle vents with oscillating louvers may comprise one or more vent units, a controller, and an application program. The one or more vent units may disperse air within a cab of a vehicle. The one or more vent units may vary the orientation of a plurality of louvers such that the air may be redirected to multiple locations within the cab. The orientation of the plurality of louvers may be determined by the controller. The application program executing on a smart device may provide a user interface for the controller.

An object of the invention is to provide one or more vent units that may be operable to vary the orientation of a plurality of louvers such that air may be redirected to multiple locations within the cab of a vehicle.

Another object of the invention is to provide a baffle that may be moved to a baffle open position to allow air flow through a vent and to a baffle closed position to block air flow.

A further object of the invention is to provide as baffle actuator to move the baffle, an azimuth actuator to swivel a gimballed vent left and right, and an elevation actuator to tilt an air director up and down.

Yet another object of the invention is to provide a controller to control the baffle actuator, azimuth actuator, and elevation actuator; said controller in wireless communication with an application program executing on a smart device.

These together with additional objects, features and advantages of the vehicle vents with oscillating louvers will be readily apparent to those of ordinary skill in the art upon reading the following detailed description of the presently preferred, but nonetheless illustrative, embodiments when taken in conjunction with the accompanying drawings.

In this respect, before explaining the current embodiments of the vehicle vents with oscillating louvers in detail, it is to be understood that the vehicle vents with oscillating louvers is not limited in its applications to the details of construction and arrangements of the components set forth in the following description or illustration. Those skilled in the art will appreciate that the concept of this disclosure may be readily utilized as a basis for the design of other structures, methods, and systems for carrying out the several purposes of the vehicle vents with oscillating louvers.

It is therefore important that the claims be regarded as including such equivalent construction insofar as they do not depart from the spirit and scope of the vehicle vents with oscillating louvers. It is also to be understood that the phraseology and terminology employed herein are for purposes of description and should not be regarded as limiting.

### BRIEF DESCRIPTION OF DRAWINGS

The accompanying drawings, which are included to provide a further understanding of the invention are incorporated in and constitute a part of this specification, illustrate an embodiment of the invention and together with the description serve to explain the principles of the invention. They are meant to be exemplary illustrations provided to enable persons skilled in the art to practice the disclosure and are not intended to limit the scope of the appended claims.

FIG. 1 is an in-use view of an embodiment of the disclosure.

FIG. 2 is a front view of an embodiment of the disclosure, illustrating a vent unit.

FIG. 3 is a side view of an embodiment of the disclosure, illustrating a vent unit.

FIG. 4 is a top view of an embodiment of the disclosure, illustrating a vent unit.

FIG. 5 is a top in-use view of an embodiment of the disclosure.

### DETAILED DESCRIPTION OF THE EMBODIMENT

The following detailed description is merely exemplary in nature and is not intended to limit the described embodiments of the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to practice the disclosure and are not intended to limit the scope of the appended claims. Furthermore, there is no intention to be bound by any expressed or implied theory presented in the preceding technical field, background, brief summary or the following detailed description. As used herein, the word “or” is intended to be inclusive.

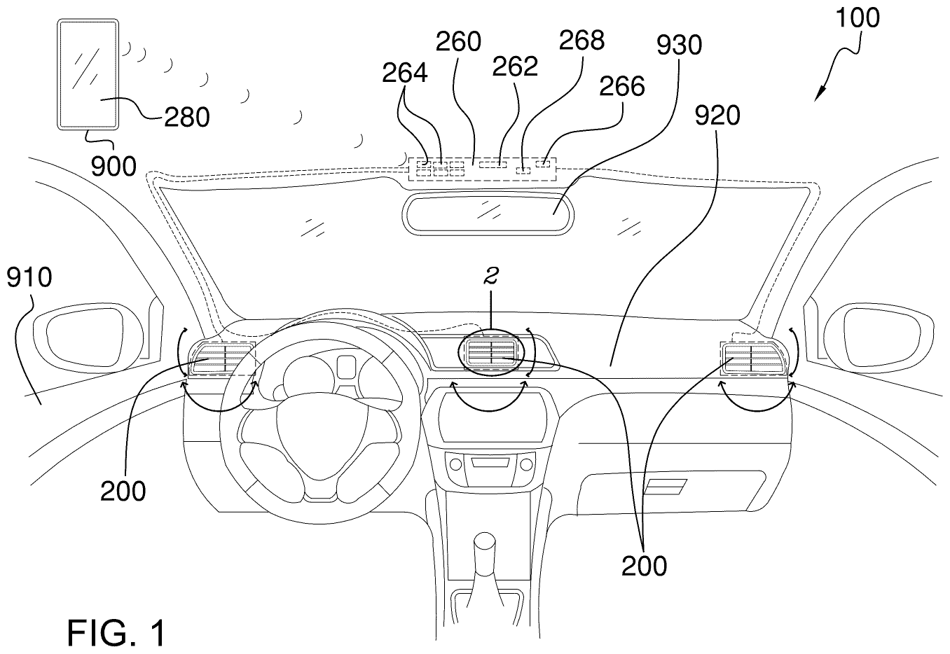

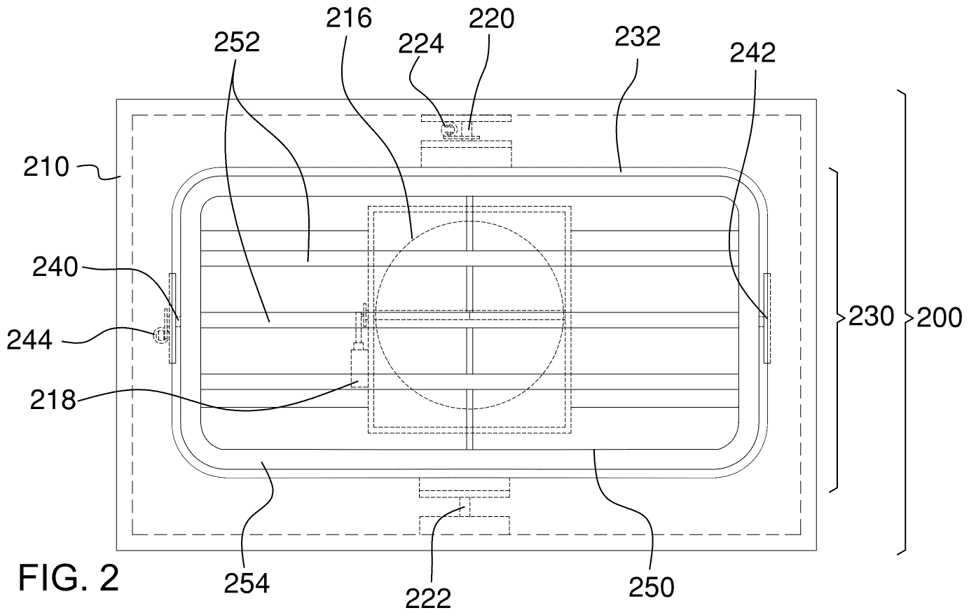

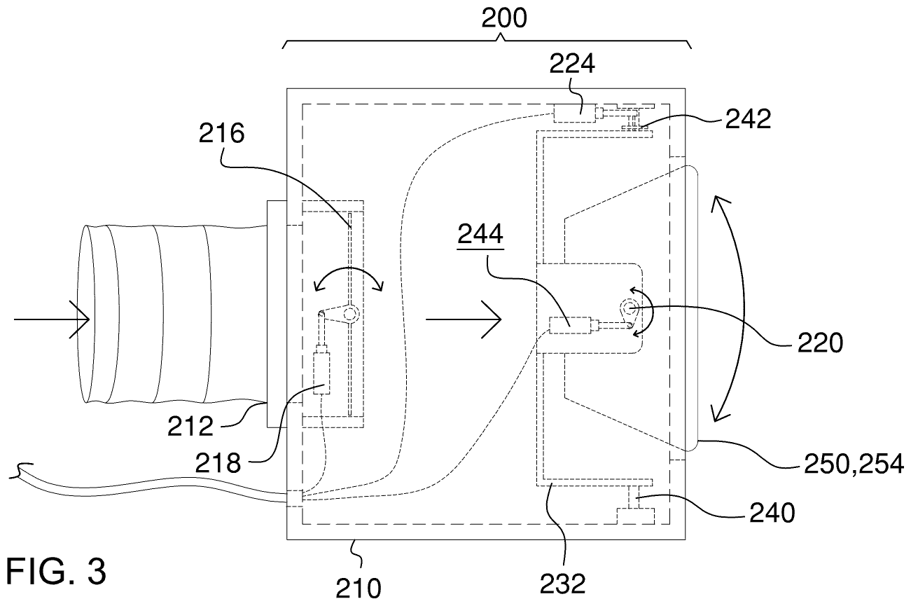

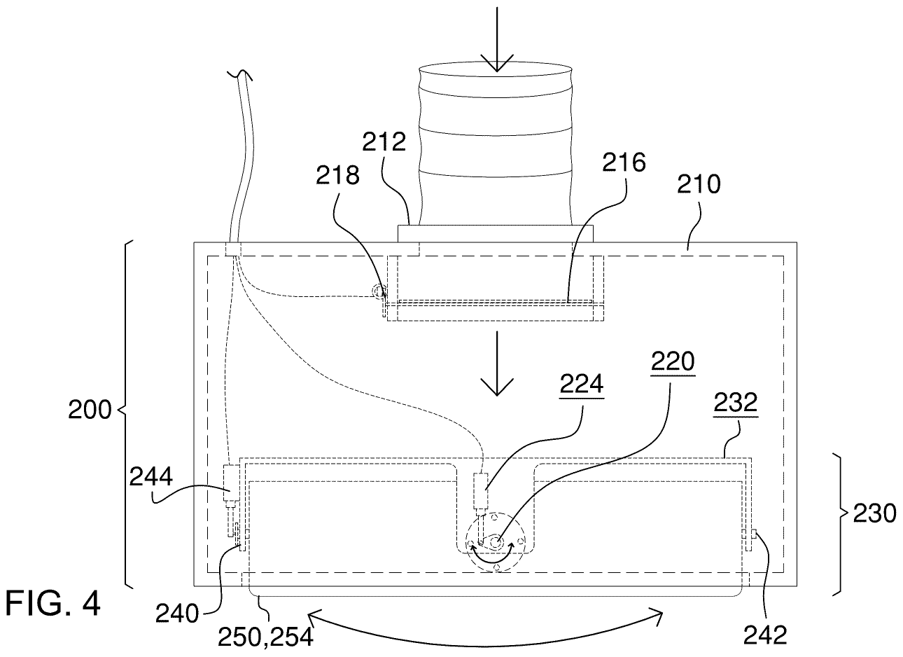

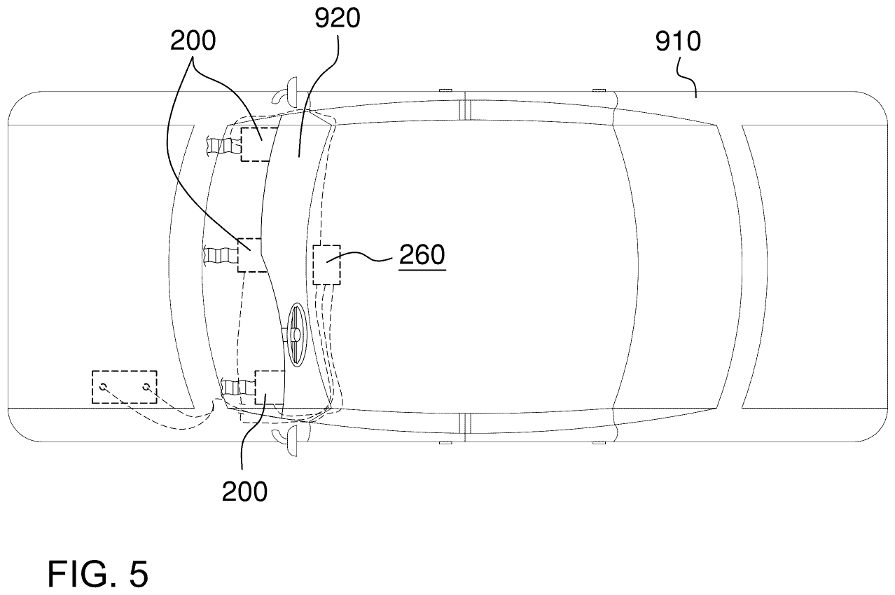

Detailed reference will now be made to a first potential embodiment of the disclosure, which is illustrated in FIGS. 1 through 5.

The vehicle vents with oscillating louvers 100 (hereinafter invention) comprises one or more vent units 200, a controller 260, and an application program 280. The one or more vent units 200 may disperse air within a cab of a vehicle 910. The one or more vent units 200 may vary the orientation of a plurality of louvers 252 such that the air may be redirected to multiple locations within the cab. The orientation of the plurality of louvers 252 may be determined by the controller 260. The application program 280 executing on a smart device 900 may provide a user interface for the controller 260.

An individual vent unit selected from the one or more vent units 200 may comprise a vent housing 210 and a gimballed vent 230. The gimballed vent 230 may be pivotably coupled to the vent housing 210. The vent housing 210 may be adapted to mount within the cab of the vehicle 910 such that the air exiting the individual vent unit may reach occupants of the cab.

The vent housing 210 may comprise a vent inlet 212 that may be coupled to a heating and cooling system of the vehicle 910. The air from the heating and cooling system may flow into the vent housing 210 through the vent inlet 212 and may then flow through the gimballed vent 230. The vent housing 210 may comprise a baffle 216 coupled to the vent inlet 212. The baffle 216 may be a barrier that may be moved between a baffle open position and a baffle closed position using a baffle actuator 218. The baffle actuator 218 may be coupled to the vent housing 210 and the baffle 216 and may be controlled by the controller 260. In the baffle open position, the air may flow past the baffle 216 and into the vent housing 210. In the baffle closed position, the baffle 216 may prevent the air from flowing into the vent housing 210. In some embodiments, the baffle 216 may be moved to intermediate positioned between the baffle open position and the baffle closed position such that the baffle 216 may regulate the volume of air that enters the vent housing 210.

The gimballed vent 230 may comprise a vent basket 232 and an air director 250. The vent basket 232 may be pivotably coupled to the vent housing 210 via an upper pivot 220 and a lower pivot 222. An azimuth actuator 224 may be coupled to the vent housing 210 and to the vent basket 232 such that the azimuth actuator 224 may pivot the vent basket 232 to the right and to the left. The vent basket 232 may comprise a left pivot 240 and a right pivot 242. The air director 250 may be pivotably coupled to the vent basket 232 via the left pivot 240 and the right pivot 242. An elevation actuator 244 may be coupled to the vent basket 232 and to the air director 250 such that the elevation actuator 244 may pivot the air director 250 up and down.

The air director 250 may comprise the plurality of louvers 252 and a director housing 254. The elevation actuator 244 may be coupled to the director housing 254. The plurality of louvers 252 may be coupled to the director housing 254. Tilting the air director 250 up and down may redirect the air up and down within the cab of the vehicle 910. The plurality of louvers 252 may be horizontally oriented, vertically oriented, or both.

The controller 260 may control the operation of the one or more vent units 200. As non-limiting examples, the controller 260 may be located within a dashboard 920, center console, or a rear view mirror 930 of the vehicle 910. The controller 260 may comprise a microcontroller 262, a plurality of actuator controllers 264, one or more temperature sensors 266, and a wireless transceiver 268. The microcontroller 262 may be a computer processor that incorporates the functions of a central processing unit in the form of one or more integrated circuits. The microcontroller 262 may accept binary data as input, may process the binary data according to instructions stored in memory, and may provide results as output. As non-limiting examples, the input may originate at the one or more temperature sensors 266 and/or the wireless transceiver 268 and the output may be directed to the wireless transceiver 268 and/or the plurality of actuator controllers 264. In some embodiments, the controller 260 may control the heating and cooling system of the vehicle 910.

The plurality of actuator controllers 264 may comprise an azimuth controller which controls the azimuth actuator 224, an elevation controller which controls the elevation actuator 244, and a baffle controller which controls the baffle actuator 218. The microcontroller 262 may change the orientation of the airflow from the one or more vent units 200 and may block and unblock airflow using the plurality of actuator controllers 264.

The microcontroller 262 may acquire temperature data from within the cab using the one or more temperature sensors 266. The microcontroller 262 may utilize the temperature data from the one or more temperature sensors 266 in calculations that determine when to allow airflow and where to direct the airflow.

The microcontroller 262 may communicate with the application program 280 executing on the smart device 900 via the wireless transceiver 268. The controller 260 may be adapted to allow a user to control the distribution and flow of the air from the smart device 900 via the wireless transceiver 268. In some embodiments, the controller 260 may comprise an operator control panel that may be adapted to allow control of the invention 100 at the front of the controller 260.

The application program 280 may be adapted to provide an ON/OFF control, a temperature control, a fan speed control, or any combination thereof to the user.

In use, one or more vent units 200 within the cab of a vehicle 910 may distribute air within the cab. The individual vent units may pivot left and right and up and down in order to redirect the air to multiple locations within the cab. A controller 260 may control the one or more vent units 200 to redirect the air where needed. The one or more vent units 200 may also comprise baffles 216 that may be independently opened and closed to allow or prevent airflow. The controller 260 may determine where to direct the airflow based upon input from the one or more temperature sensors 266 within the cab. The user may control operation of the invention 100 from an application program 280 executing on a smart device 900.

### Definitions

Unless otherwise stated, the words “up”, “down”, “top”, “bottom”, “upper”, and “lower” should be interpreted within a gravitational framework. “Down” is the direction that gravity would pull an object. “Up” is the opposite of “down”. “Bottom” is the part of an object that is down farther than any other part of the object. “Top” is the part of an object that is up farther than any other part of the object. “Upper” may refer to top and “lower” may refer to the bottom. As a non-limiting example, the upper end of a vertical shaft is the top end of the vertical shaft.

As used in this disclosure, an “application” or “app” may be software that is designed to perform one or more specific tasks on a personal computing device, smart phone, or some other computing device.

As used in this disclosure, the “azimuth” or azimuth angle, refers to an angle that is measured in a plane that is perpendicular to the either the vertical direction or the force of gravity.

As used herein, the words “control” or “controls” are intended to include any device which can cause the completion or interruption of an electrical circuit; non-limiting examples of controls include toggle switches, rocker switches, push button switches, rotary switches, electromechanical relays, solid state relays, touch sensitive interfaces and combinations thereof whether they are normally open, normally closed, momentary contact, latching contact, single pole, multi-pole, single throw, or multi-throw. In some embodiments, a control may alter an electrical property of a circuit such as resistance, inductance, or capacitance.

As used herein, the words “couple”, “couples”, “coupled” or “coupling”, may refer to connecting, either directly or indirectly, and does not necessarily imply a mechanical connection.

As used herein, the words “data” and “information” may be used interchangeably to refer to raw, unprocessed facts and to facts that have been processed, structured, organized, or presented in a context that makes the facts useful.

As used in this disclosure, “elevation” may refer to the span of the distance between a horizontal surface and a support surface as measured in the direction opposite to the force of gravity.

As used herein, “front” may indicate the side of an object that is closest to a forward direction of travel under normal use of the object or the side or part of an object that normally presents itself to view or that is normally used first. “Rear” or “back” may refer to the side that is opposite the front.

As used in this disclosure, “horizontal” may be a directional term that refers to a direction that is perpendicular to the local force of gravity. Unless specifically noted in this disclosure, the horizontal direction is always perpendicular to the vertical direction.

As used in this disclosure, a “housing” may be a rigid or semi-rigid casing that encloses and protects one or more devices.

As used in this disclosure, the term “intermediate” may refer to a location that lies between a first object and a second object

As used in this disclosure, a “microcontroller” may be a small computer, often on a single integrated circuit, containing a processor core, memory, and programmable input/output peripherals.

As used in this disclosure, “orientation” may refer to the positioning and/or angular alignment of a first object relative to a second object or relative to a reference position or reference direction.

As used herein, the word “pivot” may include any mechanical arrangement that allows for rotational motion. Non-limiting examples of pivots may include hinges, holes, posts, dowels, pins, points, rods, rivets, shafts, balls, and sockets, either individually or in combination.

As used herein, the terms “processor”, “central processor”, “central processing unit”, “CPU”, or “microprocessor” may refer to a digital device that carries out the instructions comprising a computer program by performing basic arithmetic, logical, control, and input/out operations. The term “microprocessor” may additionally imply a level of miniaturization and power reduction that makes the device suitable for portable or battery operated systems.

As used herein, “smart device” may refer to a portable electrical device comprising at least a processor, display, input device, and network connection. The input device is generally a touch screen, keyboard, or voice recognition. The network connection is generally wireless. Non-limiting examples of smart devices may include smartphones, tablets, personal digital assistants, laptop computers, and smartwatches. Smart devices may also be referred to as intelligent devices.

As used herein, “smart phone” or “smartphone” may refer to a personal communication device that incorporates cellular phone calling and texting capabilities along with advanced features. Non-limiting examples of the advanced features of a smart phone may include camera functions, multimedia functions (such as music and video recording and playback and gaming), internet functions (such as web browsing and file uploading/downloading), and Global Positioning System capabilities. A smartphone may be able to execute downloaded application programs that expand the capabilities of the smartphone.

As used in this disclosure, a “transceiver” may be a device that is used to transmit and/or receive signals. The signals may be audible, optical, or RF in nature.

As used in this disclosure, “vertical” may refer to a direction that is parallel to the local force of gravity. Unless specifically noted in this disclosure, the vertical direction is always perpendicular to horizontal.

As used in this disclosure, “wireless” may be an adjective that is used to describe a communication channel that does not require the use of physical cabling.

With respect to the above description, it is to be realized that the optimum dimensional relationship for the various components of the invention described above and in FIGS. 1 through 5, include variations in size, materials, shape, form, function, and manner of operation, assembly and use, are deemed readily apparent and obvious to one skilled in the art, and all equivalent relationships to those illustrated in the drawings and described in the specification are intended to be encompassed by the invention.

It shall be noted that those skilled in the art will readily recognize numerous adaptations and modifications which can be made to the various embodiments of the present invention which will result in an improved invention, yet all of which will fall within the spirit and scope of the present invention as defined in the following claims. Accordingly, the invention is to be limited only by the scope of the following claims and their equivalents.

What is claimed is:

1. Vehicle vents with oscillating louvers comprising:
one or more vent units, a controller, and an application program;
wherein the one or more vent units disperse air within a cab of a vehicle;
wherein the one or more vent units vary the orientation of a plurality of louvers such that the air is redirected to multiple locations within the cab;
wherein the orientation of the plurality of louvers is determined by the controller;
wherein the application program executing on a smart device provides a user interface for the controller.

2. The vehicle vents with oscillating louvers according to claim 1
wherein an individual vent unit selected from the one or more vent units comprises a vent housing and a gimballed vent;
wherein the gimballed vent is pivotably coupled to the vent housing;
wherein the vent housing is adapted to mount within the cab of the vehicle such that the air exiting the individual vent unit reaches occupants of the cab.

3. The vehicle vents with oscillating louvers according to claim 2
wherein the vent housing comprises a vent inlet that is coupled to a heating and cooling system of the vehicle;
wherein the air from the heating and cooling system flows into the vent housing through the vent inlet and then flows through the gimballed vent.

4. The vehicle vents with oscillating louvers according to claim 3
wherein the vent housing comprises a baffle coupled to the vent inlet;
wherein the baffle is a barrier that is movable between a baffle open position and a baffle closed position using a baffle actuator;
wherein the baffle actuator is coupled to the vent housing and the baffle and is controlled by the controller;
wherein in the baffle open position the air flows past the baffle and into the vent housing;
wherein in the baffle closed position the baffle prevents the air from flowing into the vent housing.

5. The vehicle vents with oscillating louvers according to claim 4
wherein the baffle is movable to intermediate positioned between the baffle open position and the baffle closed position such that the baffle regulates the volume of air that enters the vent housing.

6. The vehicle vents with oscillating louvers according to claim 4
wherein the gimballed vent comprises a vent basket and an air director;
wherein the vent basket is pivotably coupled to the vent housing via an upper pivot and a lower pivot;
wherein an azimuth actuator is coupled to the vent housing and to the vent basket such that the azimuth actuator pivots the vent basket to the right and to the left.

7. The vehicle vents with oscillating louvers according to claim 6
wherein the vent basket comprises a left pivot and a right pivot;
wherein the air director is pivotably coupled to the vent basket via the left pivot and the right pivot;
wherein an elevation actuator is coupled to the vent basket and to the air director such that the elevation actuator pivots the air director up and down.

8. The vehicle vents with oscillating louvers according to claim 7
wherein the air director comprises the plurality of louvers and a director housing;
wherein the plurality of louvers are coupled to the director housing.

9. The vehicle vents with oscillating louvers according to claim 8
wherein tilting the air director up and down redirects the air up and down within the cab of the vehicle.

10. The vehicle vents with oscillating louvers according to claim 9
wherein the plurality of louvers are horizontally oriented, vertically oriented, or both.

11. The vehicle vents with oscillating louvers according to claim 10
wherein the controller controls the operation of the one or more vent units;
wherein the controller comprises a microcontroller, a plurality of actuator controllers, one or more temperature sensors, and a wireless transceiver;
wherein the microcontroller is a computer processor that incorporates the functions of a central processing unit in the form of one or more integrated circuits;
wherein the microcontroller accepts binary data as input, processes the binary data according to instructions stored in memory, and provides results as output.

12. The vehicle vents with oscillating louvers according to claim 11
wherein the input originates at the one or more temperature sensors and/or the wireless transceiver and the output is directed to the wireless transceiver and/or the plurality of actuator controllers.

13. The vehicle vents with oscillating louvers according to claim 12
wherein the controller controls the heating and cooling system of the vehicle.

14. The vehicle vents with oscillating louvers according to claim 13
wherein the plurality of actuator controllers comprise an azimuth controller which controls the azimuth actuator, an elevation controller which controls the elevation actuator, and a baffle controller which controls the baffle actuator.

15. The vehicle vents with oscillating louvers according to claim 14
wherein the microcontroller changes the orientation of the airflow from the one or more vent units and blocks and unblocks airflow using the plurality of actuator controllers.

16. The vehicle vents with oscillating louvers according to claim 15
wherein the microcontroller acquires temperature data from within the cab using the one or more temperature sensors;
wherein the microcontroller utilizes the temperature data from the one or more temperature sensors in calculations that determine when to allow airflow and where to direct the airflow.

17. The vehicle vents with oscillating louvers according to claim 16
wherein the microcontroller communicates with the application program executing on the smart device via the wireless transceiver;
wherein the controller is adapted to allow a user to control the distribution and flow of the air from the smart device via the wireless transceiver.

18. The vehicle vents with oscillating louvers according to claim 17
wherein the controller comprises an operator control panel that is adapted to allow control of the vehicle vents with oscillating louvers at the front of the controller.

19. The vehicle vents with oscillating louvers according to claim 17
wherein the application program is adapted to provide an ON/OFF control, a temperature control, a fan speed control, or any combination thereof to the user.
